(19) United States
(12) Patent Application Publication
(10) Pub. No.: US 2021/0364844 A1
(43) Pub. Date: Nov. 25, 2021

(54) DISPLAY APPARATUS

(71) Applicants: BEIJING BOE DISPLAY TECHNOLOGY CO., LTD., Beijing (CN); BOE TECHNOLOGY GROUP CO., LTD., Beijing (CN)

(72) Inventors: Mengjie Wang, Beijing (CN); Xiaona Liu, Beijing (CN); Yuqiong Chen, Beijing (CN); Shuai Yuan, Beijing (CN); Chenchen Wu, Beijing (CN); Ning Li, Beijing (CN); Yufei Wang, Beijing (CN); Ziyi Zheng, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 16/331,237

(22) PCT Filed: May 10, 2018
(86) PCT No.: PCT/CN2018/086279

§ 371 Date: Mar. 7, 2019

(30) Foreign Application Priority Data
Jan. 2, 2018 (CN) 201810001597.X

(51) Int. Cl. G02F 1/137; G02F 1/1347; G02F 1/1335

(52) U.S. Cl. CPC G02F 1/13718; G02F 1/133516; G02F 1/13478

(57) ABSTRACT

The present disclosure is related to a display apparatus. The display apparatus may include a display panel and a mirror switcher. The mirror switcher may be configured to reflect external incident light and block display light emitted by the display panel in a mirror mode of the display apparatus, and to transmit the display light emitted by the display panel in a display mode of the display apparatus.

### CROSS-REFERENCE TO RELATED APPLICATIONS

This application claims benefit of the filing date of Chinese Patent Application No. 201810001597.X filed on Jan. 2, 2018, the disclosure of which is hereby incorporated in its entirety by reference.

### TECHNICAL FIELD

This invention relates to a display technology, and more particularly, to a display apparatus.

### BACKGROUND

With improvement of display technology, Liquid Crystal Display (LCD) apparatuses are more and more widely used in people's work and life due to their advantages such as low cost, free radiation, easiness to operate, and the like. The LCDs have been widely used in various fields such as families, public places, offices, personal electronic related products, and the like.

According to the source of light used for displaying an image, the display apparatuses are divided into a transmission type display apparatus, a reflection type display apparatus, and a mirror type display apparatus. Specifically, the light source of the transmission type display apparatus is a backlight module. Thus, when the transmission type display apparatus displays outdoors or under strong light, the contrast ratio of the displayed image is reduced. Furthermore, the light source of the reflection type display apparatus is an external light source. Thus, the reflection type display apparatus has a better display effect outdoors and under strong light. However, it is difficult to obtain high-resolution, high-contrast, and high-color-quality display images with the reflection type display apparatus. In contrast, the light source of the mirror type display apparatus is a backlight module and an external light source. Thus, it can effectively solve problems of both the transmission type display apparatus and the reflection type display apparatus.

### BRIEF SUMMARY

Accordingly, one example of the present disclosure is a display apparatus. The display apparatus may include a display panel and a mirror switcher. The mirror switcher may be configured to reflect external incident light and block display light emitted by the display panel in a non-display mode of the display apparatus, and to transmit the display light emitted by the display panel in a display mode of the display apparatus. The mirror switcher may include a second liquid crystal layer composed of cholesteric liquid crystal molecules. The mirror switcher may further include a first substrate and a second substrate opposite the first substrate, and the cholesteric liquid crystal molecules may be between the first substrate and the second substrate. The display panel may include an array substrate, an opposite substrate, and a first liquid crystal layer. The array substrate and the opposite substrate may be arranged opposite each other and the first liquid crystal layer is arranged between the array substrate and the opposite substrate. The mirror switcher may be at a side of the opposite substrate of the display panel distal to the array substrate of the display panel. The mirror switcher and the opposite substrate may share a common substrate.

The mirror switcher may be at a side of the opposite substrate of the display panel facing the array substrate of the display panel. The first substrate may share a base with the opposite substrate of the display panel.

In the non-display mode of the display apparatus, the cholesteric liquid crystal molecules may be arranged in a planar texture state under no action of an electric field and the second liquid crystal layer may reflect the external incident light. A product of a pitch of the cholesteric liquid crystal molecules and an average refractive index of the second liquid crystal layer composed of the cholesteric liquid crystal molecules may approximately equal to a wavelength of the external incident light. In the non-display mode of the display apparatus, the second liquid crystal layer may block the display light emitted by the display panel.

In the display mode of the display apparatus, the cholesteric liquid crystal molecules may be in a homeotropic state under action of an electric field, and the second liquid crystal layer may transmit the display light emitted by the display panel.

A light source of the display apparatus may be a backlight module.

Another example of the present disclosure is a method of forming a display apparatus. The method of forming a display apparatus may include forming a display panel and forming a mirror switcher using the display panel as a substrate of the mirror switcher.

In some embodiments, the method of forming a display apparatus includes, in this order, forming a display panel without a color film layer and forming a mirror switcher using the display panel as a substrate of the mirror switcher. The mirror switch includes the color film layer. The color film layer is at a side of the mirror switcher opposite from the display panel. In one embodiment, forming the mirror switcher includes in this order forming the color film layer on a vase substrate and forming the mirror switcher using the base substrate of the color film layer as the substrate of the mirror switcher. In another embodiment, forming the mirror switcher includes in this order forming the mirror switcher and adhering the color film layer on the mirror switcher.

In some embodiments, the method of forming a display apparatus includes, in this order, forming a mirror switcher, the mirror switch comprising a color film layer and forming a display panel using a side of the mirror snitcher opposite from the color film layer as an opposite substrate of the display panel. In one embodiment, forming the mirror switcher includes in this order forming the color film layer on a base substrate and forming the mirror switcher using the base substrate with the color film layer as a substrate of the mirror switcher. In another embodiment, forming the mirror switcher includes in this order forming the mirror switcher and adhering the color film layer on the mirror switcher.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of a display apparatus according to an embodiment of the present disclosure;

FIG. 2 is a partial cross-sectional view of a display apparatus according to an embodiment of the present disclosure;

FIG. 3 is a schematic diagram of light propagation in a display apparatus according to an embodiment of the present disclosure;

FIG. 4 is a schematic diagram of light propagation in a display apparatus according, to an embodiment of the present disclosure.

FIG. 5 is a partial cross-sectional view of a display apparatus according to an embodiment of the present disclosure;

FIG. 6 is a partial cross-sectional view of a display apparatus according to an embodiment of the present disclosure; and

FIG. 7 is a partial cross-sectional view of a display apparatus according to an embodiment of the present disclosure;

### DETAILED DESCRIPTION

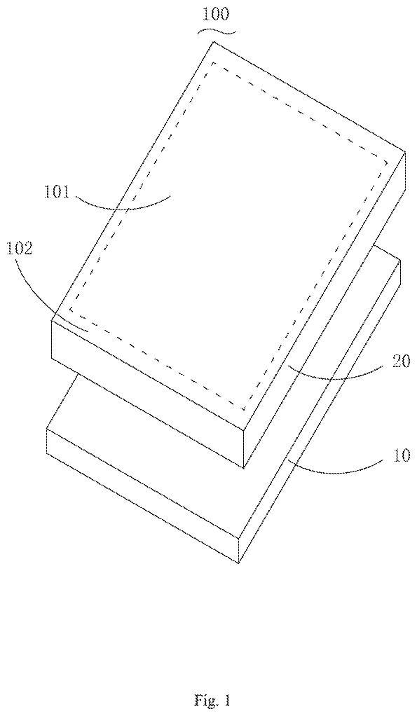

The present disclosure will be described in further detail with reference to the accompanying drawings and embodiments in order to provide a better understanding by those skilled in the art of the technical solutions of the present disclosure. Throughout the description of the disclosure, reference is made to FIGS. 1-4. When referring to the figures, like structures and elements shown throughout are indicated with like reference numerals. The described embodiments are part of the embodiments of the present disclosure, and are not all embodiments. According to the embodiments of the present disclosure, all other embodiments obtained by persons of ordinary skill in the art without creative efforts, belong to the protection scope of the disclosure.

In the description of the present disclosure, the terms “first” and “second” may be used for illustration purposes only and are not to be construed as indicating or implying relative importance or implied reference to the quantity of indicated technical features. Thus, features defined by the terms “first” and “second” may explicitly or implicitly include one or more of the features. In the description of the present disclosure, the meaning of “plural” is two or more unless otherwise specifically and specifically defined.

In the description of the specification, references made to the term “one embodiment,” “some embodiments,” and “exemplary embodiments,” “example,” and “specific example,” or “some examples” and the like are intended to refer that specific features and structures, materials or characteristics described in connection with the embodiment or example that are included in at least one embodiment or example of the present disclosure. The schematic expression of the terms does not necessarily refer to the same embodiment or example. Moreover, the specific features, structures, materials or characteristics described may be included in any suitable manner in any one or more embodiments or examples.

The present mirror type display apparatus is mainly provided with a reflective polarizer having a function of improving brightness. The polarizer with this specific function is expensive, which leads to relatively high cost of the mirror type display apparatus. Moreover, the light reflected by the reflective polarizer can overlap the display light and cause interference on the display image.

FIG. 1 is a perspective view of a display apparatus according to an embodiment of the present disclosure. As shown in FIG. 1, the display apparatus 100 includes a display panel 10 and a mirror switcher 20. The display panel 10 and the mirror switcher 20 are arranged in a stacked structure. The mirror switcher 20 is located at a light exiting side of the display panel 10. The mirror switcher 20 may be used for reflecting external incident light and blocking display light emitted by the display panel 10 so as to switch the display apparatus 100 into a mirror mode. Alternatively, the mirror switcher 20 may be used for transmitting the display light emitted by the display panel 10 so as to switch the display apparatus 100 into a display mode. The display apparatus 100 may further include a display region 101 and a peripheral region 102 surrounding the display region 101. The display region 101 is mainly used for realizing the display output function of the display apparatus 100. The peripheral region 102 is mainly used for wiring and the like.

In the embodiment, the mirror switcher 20 is located at the light exiting side of the display panel 10. In one embodiment, the mirror switcher 20 may be located at an outer side of a light exiting surface at the light exiting side of the display panel 10. In another embodiment, the mirror switcher 20 may also be located at an inner side of a light exiting surface at the light exiting side of the display panel 10. It is not limited herein.

The mirror switcher 20 is arranged at the light exiting side of the display panel. As such, when the display apparatus displays, there is only one emergent light, thereby avoiding interference of the display image by the reflected light using a reflective polarizer.

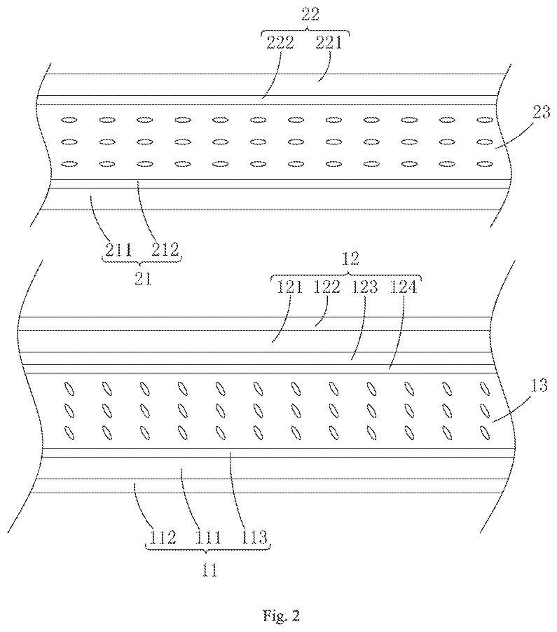

FIG. 2 is a partial cross-sectional view of a display apparatus shown in FIG. 1. As shown in FIG. 2, the display panel 10 includes an array substrate 11, an opposite substrate 12, and a first liquid crystal layer 13. The array substrate 11 and the opposite substrate 12 are arranged opposite each other. The first liquid crystal layer 13 is sandwiched between the array substrate 11 and the opposite substrate 12.

In one embodiment, the array substrate 11 includes a first base 111, a first polarizer 112, and a first electrode 113. The first base 111, the first polarizer 112, and the first electrode 113 are arranged in a stacked structure. The first base 111 is located between the first polarizer 112 and the first electrode 113. The first polarizer 112 is located at a side of the first base 111 farther away from the first liquid crystal layer 13. The first electrode 113 is located at a side of the first base 111 closer to the first liquid crystal layer 13. In addition, the array substrate 11 may further include thin film transistors (not shown) on the first base 111 and an alignment film (not shown).

In one embodiment, the opposite substrate 12 includes a second base 121, a second polarizer 122, a color film layer 123, and a second electrode 124. The second base 121, the second polarizer 122, the color film layer 123, and the second electrode 124 are arranged in a stacked structure. The second base 121 is located between the second polarizer 122 and the color film layer 123. The second polarizer 122 is located at a side of the second base 121 farther away from the first liquid crystal layer 13. The color film layer 123 is located at a side of the second base 121 closer to the first liquid crystal layer 13. The second electrode 124 is located at a side of the color film layer 123 closer to the first liquid crystal layer 13.

In one embodiment, the first electrode 113 is a pixel electrode, and the second electrode 124 is a common electrode.

In the embodiment, the common electrode, namely the second electrode 124, is arranged on the second base 121 for illustration purpose only. However, embodiments are not limited to this. In other embodiments, the common electrode, namely the second electrode 124, can also be arranged on the first base 111, and it is not limited to this.

In the embodiment, a Twisted Nematic (TN) liquid crystal display apparatus is used for illustration purpose, but is not limited thereto. In other embodiments, the display panel 10 may also be an in-plane switching (IPS) type liquid crystal display apparatus, an Advanced Super Dimension Switch type liquid crystal display apparatus (AD-SDS), or an Advanced Super Dimension Switch (HADS) type liquid crystal display apparatus with a high aperture ratio based on an ADS mode.

In one embodiment, the mirror switcher 20 and the display panel 10 are arranged in a stacked structure. The mirror switcher 20 is located at a side of the opposite substrate 12 farther away from the array substrate 11. The mirror switcher 20 includes a first substrate 21, a second substrate 22, and a second liquid crystal layer 23. The first substrate 21 and the second substrate 22 are arranged facing each other. The second liquid crystal layer 23 is sandwiched between the first substrate 21 and the second substrate 22. The second substrate 22 is located at a side of the first substrate 21 farther away from the opposite substrate 12.

In one embodiment, the mirror switcher 20 is located at a side of the opposite substrate 12 of the display panel 10 farther away from the array substrate 11 of the display panel 10. This is for illustration purpose only, and is not limited thereto in other embodiments, the mirror switcher 20 may be located at a side of the opposite substrate 12 of the display panel 10 closer to the array substrate 11 of the display panel 10, and is not limited hereto.

In one embodiment, the mirror switcher 20 is located at a side of the opposite substrate 12 of the display panel 10 farther away from the array substrate 11 of the display panel 10. The mirror switcher 20 may be located at a side of the second base 121 of the opposite substrate 12 farther away from the army substrate 11. The mirror switcher 20 may also be located at a side of the opposite substrate 12 of the display panel 10 closer to the array substrate 11 of the display panel 10. That is, the mirror switcher 20 is located at a side of the second base 121 of the opposite substrate 12 closer to the array substrate 11.

In one embodiment, the first substrate 21 includes a third base 211 and a third electrode 212. The third electrode 212 is arranged on the third base 211. The third electrode 212 is located at a side of the third base 211 closer to the second liquid crystal layer 23.

In one embodiment, the second substrate 22 includes a fourth base 221 and a fourth electrode 222. The fourth electrode 222 is arranged on the fourth base 221. The fourth electrode 222 is located at a side of the fourth base 221 closer to the second liquid crystal layer 23.

In one embodiment, the second liquid crystal layer 23 is a liquid crystal layer composed of cholesteric liquid crystal molecules. The pitch of the cholesteric liquid crystal molecules needs to have a certain corresponding relationship with the external incident light. The product of the pitch of the cholesteric liquid crystal molecules and the average refractive index of the liquid crystal layer composed of the cholesteric liquid crystal molecules corresponds to a wavelength of the external incident light. Specifically, because the cholesteric liquid crystal molecules have two refractive indexes, the average refractive index of the cholesteric liquid crystal molecules can be obtained by averaging the two refractive indexes of the cholesteric liquid crystal molecules. The average refractive index of the cholesteric crystal molecules can be deemed as the average refractive index of the liquid crystal layer composed of the cholesteric crystal molecules. Also, the product of the average refractive index of the liquid crystal layer composed of the cholesteric liquid crystal molecules and the pitch of the cholesteric liquid crystal molecules determines the center wavelength of the light which can be reflected by the liquid crystal layer composed of the cholesteric liquid crystal molecules. Furthermore, there is a difference between the two refractive indexes of the cholesteric liquid crystal molecules. The product of the difference between the two refractive indexes of the cholesteric liquid crystal molecules and the pitch of the cholesteric liquid crystal molecules determines a range of the wavelength of light which can be reflected by the liquid crystal layer composed of the cholesteric liquid crystal molecules. According to the two factors mentioned above, the liquid crystal layer composed of the cholesteric liquid crystal molecules can reflect light with a certain range of wavelengths so that selective reflection of the light can be achieved.

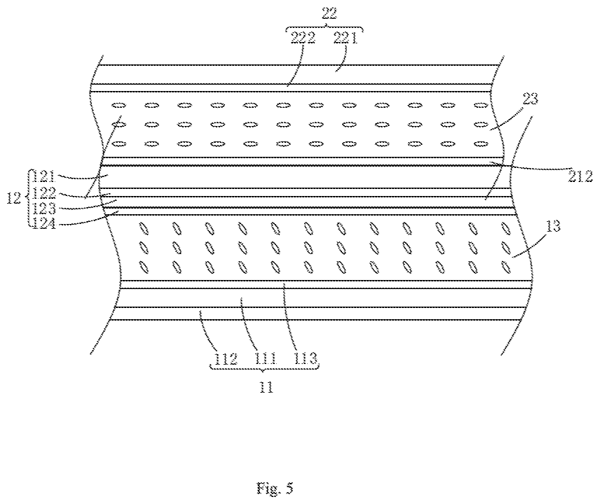

In one embodiment, the mirror switcher 20 and the display panel 10 are respectively arranged, and then they are aligned and assembled. But it is not limited thereto. In other embodiments, in order to reduce the thickness of the display apparatus 100 or because of other reasons, the mirror switcher 20 and the display panel 10 can also share a common film layer or a base and the like. For example, the mirror switcher 20 may be located at an outer side of the light exiting surface at the light exiting side of the display panel 10. That the mirror switcher 20 is located at a side of the opposite substrate 21 farther away from the array substrate 12, and one of the first substrate 21 and the second substrate 22 can share a same base with the opposite substrate 12. In one embodiment, as shown in FIG. 5, the mirror switcher 20 is located next to a side of the opposite substrate 12 farther away or opposite from the array substrate 11 of the display panel. Furthermore, a third electrode 212 and an opposite substrate 12 are arranged between the first liquid crystal layer 13 and the second liquid crystal layer 23. The first base 21 of the mirror switcher 20 shares the second base 121 with the opposite substrate 12. As such, a third base 211 is not included in the display apparatus.

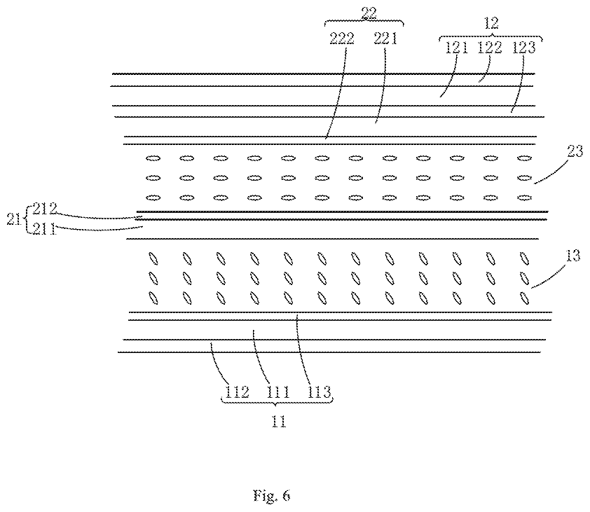

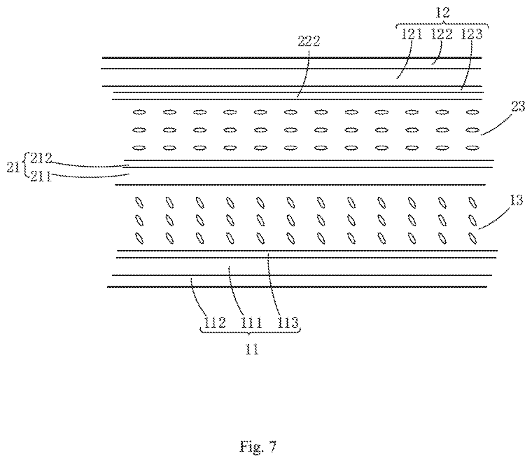

In another embodiment, the mirror switcher 20 may be located at an inner side of the light exiting surface at the light exiting side of the display panel 10. That is, the mirror switcher 20 is located between the array substrate 11 and the opposite substrate 12, as shown in FIG. 6. Furthermore, one of the first substrate 21 and the second substrate 22 can also share a same base with the opposite substrate 12. In one embodiment, as shown in FIG. 7, the mirror switcher 20 is located between the array substrate 11 and the opposite substrate 12. Furthermore, the first substrate 21 of the mirror switcher shares a same base, the third base 211, with the array substrate. The second substrate 22 of the mirror switcher shares a same base, the second base 121, with the opposite substrate.

In this way, one of the first substrate 21 and the second substrate 22 of the mirror switcher 20 can share a base with the opposite substrate 12 of the display panel 10. This can reduce not only the thickness of the display apparatus 100, but also the corresponding repeated procedures during the manufacturing, thereby saving manufacturing time.

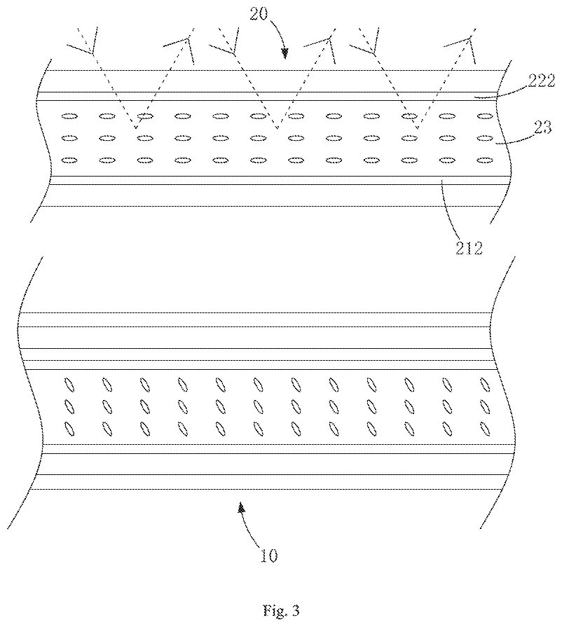

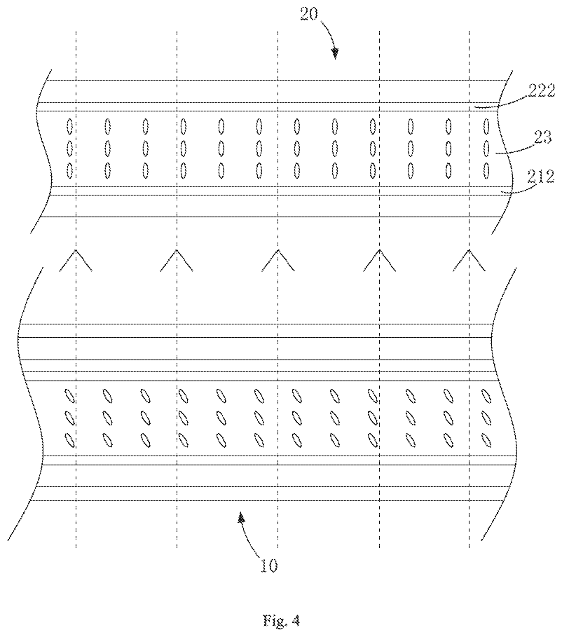

FIG. 3 is a schematic diagram of light propagation in the display apparatus shown in FIG. 2. FIG. 4 is schematic diagram of another light propagation in the display apparatus shown in FIG. 2. As shown in FIG. 3 and FIG. 4, when the third electrode 212 and the fourth electrode 222 in the mirror switcher 20 are turned off power, there is no electric field formed between the third electrode 212 and the fourth electrode 222. At this moment, the second liquid crystal layer 23, namely, the liquid crystal layer composed of the cholesteric liquid crystal molecules is not applied with a voltage, and the cholesteric liquid crystal molecules are arranged in a planar texture state. The second liquid crystal layer 23, namely the liquid crystal layer composed of the cholesteric liquid crystal molecules, is in a reflection mode and can reflect light. As such, it can reflect the external incident light, as shown by the dashed line in FIG. 3, and block the display light emitted by the display panel 10. Therefore, no matter whether the display panel 10 emits a display light or not, the display apparatus 100 is in a mirror or non-display mode.

When the third electrode 212 and the fourth electrode 222 in the mirror switcher 20 are turned on power, an electric field is formed between the third electrode 212 and the fourth electrode 222. As such, the second liquid crystal layer 23, namely the liquid crystal layer composed of the cholesteric liquid crystal molecules, is applied with a voltage, and the cholesteric liquid crystal molecules are in a homeotropic state. Thereby, the liquid crystal layer is in a light transmitting mode and transmits light. As such, it can transmit the external incident light and the display light emitted by the display panel 10 as shown by the dashed lines in FIG. 4. Therefore, when the display panel 10 emits display light, the display apparatus 100 is in a display mode.

In this way, by controlling the different polarization states of the cholesteric liquid crystal molecules in the mirror switcher 20, the liquid crystal layer composed of the cholesteric liquid crystal molecules can reflect or transmit the light, so that the mirror switcher 20 can switch between reflection and transmission modes of the light. Compared with using a reflective polarizer, it is simple to manufacture a liquid crystal cell and cost is low according to embodiments of the present disclosure. When the display apparatuses in the display mode, the display image is not interfered by the reflected light.

The display apparatus provided by the embodiment of the present disclosure includes a display panel and a mirror switcher. The mirror switcher is located at a light exiting side of the display panel. The mirror switcher is used for reflecting the external incident light and blocking the display light emitted by the display panel. As such, the display apparatus is switched to a mirror mode. Alternatively, the mirror switcher is used for transmitting the display light emitted by the display panel so as to switch the display apparatus to a display mode. The mirror switcher is arranged at a light exiting side of the display panel. As such, the mirror switcher is used for reflecting external incident tight and blocking the display light emitted by the display panel from transmitting out. Alternatively, the mirror switcher is used for transmitting the display light emitted by the display panel. As such, when the display apparatus is in a display mode, there is only one emergent light, thereby avoiding interference of the display image caused by the light reflected by the reflective polarizer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A display apparatus, comprising:
a display panel; and
a mirror switcher,
wherein the mirror switcher is configured to reflect external incident light and block display light emitted by the display panel in a non-display mode of the display apparatus, and to transmit the display light emitted by the display panel in a display mode of the display apparatus.

2. The display apparatus according to claim 1, wherein the mirror switcher comprises a second liquid crystal layer composed of cholesteric liquid crystal molecules.

3. The display apparatus according to claim 2, wherein the mirror switcher further comprises a first substrate and a second substrate opposite the first substrate, and the cholesteric liquid crystal molecules are between the first substrate and the second substrate.

4. The display apparatus according to claim 3, wherein the display panel comprises an array substrate, an opposite substrate, and a first liquid crystal layer,
wherein the array substrate and the opposite substrate are arranged opposite each other and the first liquid crystal layer is arranged between the array substrate and the opposite substrate.

5. The display apparatus according to claim 4, wherein the mirror switcher is at a side of the opposite substrate of the display panel distal to the array substrate of the display panel.

6. The display apparatus according to claim 5, wherein the mirror switcher and the opposite substrate share a common substrate.

7. The display apparatus according to claim 4, wherein the mirror switcher is at a side of the opposite substrate of the display panel facing the array substrate of the display panel.

8. The display apparatus according to claim 7, wherein the first substrate shares a base with the opposite substrate of the display panel.

9. The display apparatus according to claim 2, wherein in the non-display mode of the display apparatus, the cholesteric liquid crystal molecules are arranged in a planar texture state under no action of an electric field and the second liquid crystal layer reflects the external incident light.

10. The display apparatus according to claim 9, wherein a product of a pitch of the cholesteric liquid crystal molecules and an average refractive index of the second liquid crystal layer composed of the cholesteric liquid crystal molecules approximately equals to a wavelength of the external incident light.

11. The display apparatus according to claim 9, wherein in the non-display mode of the display apparatus, the second liquid crystal layer blocks the display light emitted by the display panel.

12. The display apparatus according to claim 2, wherein in the display mode of the display apparatus, the cholesteric liquid crystal molecules are in a homeotropic state under action of an electric field, and the second liquid crystal layer transmits the display light emitted by the display panel.

13. The display apparatus according to claim 1, wherein a light source of the display apparatus is a backlight module.

14. (canceled)

15. A method of forming a display apparatus, comprising in this order:
forming a display panel without a color film layer; and forming a mirror switcher using the display panel as a substrate of the mirror switcher, the mirror switch comprising the color film layer, wherein the color film layer is at a side of the mirror switcher opposite from the display panel.

16. The method of forming a display apparatus according to claim 15, wherein forming the mirror switcher comprises in this order: forming the color film layer on a base substrate, and forming the mirror switcher using the base substrate of the color film layer as the substrate of the mirror switcher.

17. The method of forming a display apparatus according to claim 15, wherein forming the mirror switcher comprises in this order: forming the mirror switcher, and adhering the color film layer on the mirror switcher.

18. A method of forming a display apparatus, comprising in this order: forming a mirror switcher, the mirror switch comprising a color film layer, and forming a display panel using a side of the mirror switcher opposite from the color film layer as an opposite substrate of the display panel.

19. The method of forming a display apparatus according to claim 18, wherein forming the mirror switcher comprises in this order: forming the color film layer on a base substrate, and forming the mirror switcher using the base substrate of the color film layer as a substrate of the mirror switcher.

20. The method of forming a display apparatus according to claim 18, wherein forming the mirror switcher comprises in this order: forming the mirror switcher, and adhering the color film layer on the mirror switcher.
